(19) United States
(12) Patent Application Publication
(10) Pub. No.: US 2003/0133841 A1
(43) Pub. Date: Jul. 17, 2003

(54) End element for capillaries or chip channels

(76) Inventors: Dagmar Weber, Hamburg (DE); Angelika Muscate-Magnussen, Hamburg (DE)

Correspondence Address: Paul D Greeley, Ohlandt Greeley Ruggiero & Perle, Suite 903, One Landmark Square, Stamford, CT, 06901, US

(21) Appl. No.: 10/203,070

(22) PCT Filed: Feb. 16, 2001
(86) PCT No.: PCT/EP01/01733

(51) Int. Cl. G01N 27/447; B01L 3/00

(52) U.S. Cl. 422/99; 204/601

(57) ABSTRACT

An end element (10) for capillaries of chip channels for use in capillary electrophoresis or in electrochromatography or in high performance liquid chromatography comprises an attachment member (12) and a liquid-permeable membrane (14). The attachment member (12) is connected to the capillary (16) or the chip channel. The liquid-permeable membrane (14) serves for terminating the capillary (16) or the chip channel and is provided for retaining carrier material (18) contained in the capillary (16) or the chip channel. The liquid permeable membrane (14) comprises a microsieve or porous film.

The invention relates to an end element for capillaries or chip channels for use in capillary electrophoresis or in capillary electrochromatography, liquid chromatography and micro-liquid chromatography or in high performance liquid chromatography.

In the field of chemical and biochemical analysis microseparation processes as capillary electrophoresis (CE) or capillary electrochromatography (CEC) or liquid chromatography (LC) or micro-liquid chromatography or high performance liquid chromatography (HPLC) play a very important role due to their high separation efficiencies in the range of a few hundred thousand plates per meter and the low analyte volumes. The basic idea of CE is to separate analytes by their electrophoretic mobility, which leads to very efficient separations of charged analytes.

Another approach to separate not only charged but also neutral molecules is CEC, which combines the advantages of capillary liquid chromatography and capillary electrophoresis (CE). The general idea of chromatographic separation processes is to dissolve the sample in a mobile phase. This mobile phase is moved through a non-mixable stationary phase which is located e.g. in a column or a chip channel, or is fixed onto a surface.

The two phases have to be chosen in such a way that the different sample compounds have different affinities to the mobile and the stationary phase. Substances having a high affinity to the stationary phase are moved only very slowly with the mobile phase. On the other hand, substances with a low affinity to the stationary phase are moved very quickly with the mobile phase. Due to this behavior it is possible to perform a discrete separation of the sample.

In CEC the stationary phase consists in most cases of a fused silica capillary or a chip channel filled with conventional packing material as known in HPLC, e.g. Hypersil (Separations Group), Nucleosil (Macherey-Nagel Co.), ISRP GFF1-S5-80 (Regis Technologies, Inc.) which is retained in the capillary by two frits at the capillary ends.

In CEC as well as in CE sample detection is commonly done by UV absorption. Unfortunately, the sensitivity of this method is comparably poor, due to the short optical pathlength of the capillary. However, the more sensitive on column detection via laser induced fluorescence is limited to fluorescent marked analytes. Consequently, it is sometimes necessary to couple the separation system to a universal sensitive detection unit like mass spectrometry or light scattering techniques.

To improve the sensitivity of a CE or CEC system it is also possible to preconcentrate or clean-up the sample in line with the capillary directly or on the capillary or chip before the separation.

The packing of columns or chip channels is a very critical issue in CEC applications. The following description of a packing process is directed to columns.

The whole procedure consists of two parts. Firstly, the capillary is filled with the packing material and secondly the beads have to be immobilized, otherwise they would be rinsed out of the capillary during the separation procedure, especially due to the applied EOF or an applied pressure. In most cases, columns are packed by slurry packing. This means that the beads are suspended in a suitable solvent and filled into the capillary by applying a high pressure (up to 800 bar). During this filling procedure the capillary is plugged at one end with e.g. an HPLC frit which allows the solvent to flow through but retains the particles in the column. There are also packing procedures based on the electrophoretic mobility of the beads or based on centripetal forces described.

The more difficult part of the column production is the immobilization step. Commonly, this is realized by two frits, located at the capillary inlet and outlet. They consist of sintered packing material over a length of 2-3 mm. After filling the capillary with the packing material, the outlet frit at one end of the column is burned. This is still performed under high pressure by heating the capillary with a wire which is coiled around it at the desired frit position for a few seconds. The particles in the capillary sinter together. Now the pressure releases and the column is rinsed to remove the packing material from the capillary end. Analogous to this procedure the inlet frit is burned, again under pressure.

Unfortunately, the high sintering temperatures (500-600° C.) lead to dramatic changes of the surface properties of the packing material.

When exposed to temperatures above 180° C., octadecylmodified silica for instance looses its C18 groups, which are essential for the chromatographic separation process in the column and therefore for the peak width. The sintered frits have a lower permeability than the rest of the packed bed, because some parts of the beads fall apart and clog the frits during the heating. Consequently, the flow velocity changes at the frits, which is a well known reason for air bubble formations.

Another known reason for EOF changes in CEC frits and resulting air bubbles is a shrinking process in the frits. The beads dry when applied to high temperatures and shrink irreversibly. The formation of air bubbles is not only a kind of electrical resistance for the separation current but can also be a reason for rips in the bead bed.

In addition to that, the sintering temperature also destroys the polyimid coating of the capillary which makes it fragile. The production of reproducible CEC columns using the just described method is impossible due to the mentioned problems.

Another method to retain packing material in a column is described in U.S. Pat. No. 5,858,241. To retain the packing material, the whole bed is immobilized by a hydrothermal treatment after having filled the capillary with slurry. This packing procedure is based on the irreversible agglomeration of silica based packing material to form a monolythic bed. The difficulty of this method was to establish a sintering process which does neither affect the chromatographic, mechanical or chemical properties of the packing material nor the polyimid coating of the capillary. The applied temperature had on the one hand to be high enough to immobilize the beads but on the other hand it should not split the n-alkylgroups from the silica. The pore size and structure should also not be affected by the sintering temperature. The sintering time had also had to be optimized. Due to different flow rates during the packing and immobilization procedures and the aging and positioning accuracy of the hot wire, which was used to apply the high temperatures, the reproducibility of these columns was poor.

Within another immobilization process of a whole bed of octadecylated silica microsheres, most of the C-18 groups were removed during the sintering process in an oven at 360° C. Therefore a chemically retreatment with dimethyloctadecylchlorosilane to rebctadecylate the beads was necessary.

A fritless method for retaining packing material in the CEC columns is based on the so called “keystone” effect. This means that the capillary was tapered to a diameter of approx. 10 μm which was sufficient to retain particles down to 3 μm in the column. No additional frits were necessary. Unfortunately, the reproducibility of the fritless packed capillaries was very poor. With up to 50% of the capillaries occurred problems during the conditioning procedure. The particles were flushed out by the EOF. Another problem is that tapered capillaries are very fragile and therefore more difficult to handle than non-tapered coated capillaries.

When working with negatively charged silica particles as packing material, it is possible to provide only one frit at the capillary inlet and no end frit. It was possible to attract them by the positive charge at the inlet vial. This force was stronger than the EOF which otherwise forces the particles to be flushed out. This method should have some advantages to the other described methods in terms of homogenity and density of the bed or in the frits. However, this method is limited to charged packing materials.

U.S. Pat. No. 5,985,140 describes a cartridge for high performance liquid chromatography (HPLC). To close the ends of the tube, a filter in combination with an end plug is used on each side. The filter is made from sintered stainless steel having a pore size that decreases in the direction of the flow. To insert the filter and the end plug, the tube has a shoulder on each side. Additionally, it is necessary to hold the end plug in place. To fix the end plug, the edges of the tube are curved inwardly over a frustum of the end plug. Therefore, the fixing of the end plugs is relatively complicated. Additionally, the tube has to be made of a material that can be bent easily. It is impossible to use a tube made of glass or the like.

Another column for chromatography is described in DE 90 16 515. To close the ends of the column, a filter element is used together with an end plug. The end plug is put into the column. To hold the end plug in place, the end plug has a circular shoulder or projection latching into a circular recess. The recesses are formed on the inner surface of the column. To hold the end plugs in place by latching, the column needs to be made of a resilient material.

Therefore, it is an object of the invention to improve the retaining of packing material in capillaries or chip channels.

This object is solved by the end element according to claims 1 and 7, respectively, and by a method according to claim 12.

According to the invention, an end element for capillaries or chip channels for use in capillary electrophoresis or in capillary electrochromatography, liquid chromatography and micro-liquid chromatography or in high performance liquid chromatography is provided. The end element comprises an attachment member to be connected to the capillary or the chip channel and a liquid-permeable membrane terminating the capillary and the chip channel, respectively. The membrane is provided for retaining carrier material contained in the capillary and the chip channel, respectively. The membrane is made of a thin, in general flexible material. Preferably, the membrane has a thickness of less than 50 μm, particularly less than 30 μm.

Depending on the geometry and the material of the end element, it can be used for a variety of analytic applications, especially in CE and CEC.

Due to the absence of any thermal treatment like frit burning or a whole bed immobilization, the packing material is not limited to silica based beads or chargeable beads like when retaining the material by electrical forces. With the end element according to the invention, it is now possible to create columns filled with every kind of beads, also more sensitive kinds like magnetic beads or polymer beads, which enables the work in the high pH range.

Furthermore it was possible to produce very short columns (<8 cm) for fast separations. By using the common frit burning packing method for short columns, the frits occupy up to 20% of the whole bed which strongly influences the EOF. The bottoms of the plug on frit can be very thin (10 μm) and therefore do not effect the separation.

The end element according to the invention can be connected very tightly to the capillaries or chip channels. It is not needed to fix or glue the end element to the capillaries or the chip channels. The end element can be connected to the capillary by plugging on and to the chip channel by insertion. This can be simply done by hand or, if desired, in an automated process within a few seconds. The end element is preferably held in place by friction forces. The end element used for capillaries is preferably surrounding the end of the capillary. It is not inserted into the capillary. Therefore, the end element is not reducing the cross section of the orifice of the capillary.

The dead volume between the bed and the bottom of the device is minimized. It is possible to reduce it down to 500 pl or less yet, which means a lower chance of generating air bubbles. For the same reason there is no more need to pack the column with a bead suspension. Dry packing methods could now be used to obtain improved column stability, as it is forecasted in the literature (Maloney, Electrophoresis, Wiley-VCH 1999, 20, 2060-2065).

In addition to this, common problems like heat-caused changes in the chemical structure of the column e.g. the removal of C-18 groups and the related losses in the separation quality as described before, cannot occur. Neither could there occur mechanical problems like an irreproducible gradient in the packing material as known in whole immobilized beds nor damages of the polyimid coating. Follow-up treatment procedures, e.g. to rebuild SiOH groups, were not necessary. The packing parameters did not have to be adapted to the used beads.

Therefore, the use of the end element according to the invention saves time and the reproducibility of CEC columns increased enormously.

Preferably, the liquid-permeable membrane of the end element comprises a microsieve or a porous film. Therefore, even very small carrier material is retained in the capillary or chip channel. The pore size of the membrane is preferably less than 50 μm. Particularly, the pore density is at least 4% preferably at least 10% and most preferably at least 25%.

To obtain a homogeneous flow of the material to be analyzed by CE or CEC or HPLC, the pores are distributed substantially homogenously across the surface of the membrane.

In a preferred embodiment, the end element comprises an outlet element of tapering cross section comprising an outlet orifice facing away from the capillary or the chip channel. If the outlet element is made of an electrically conductive material or is coated with an electrically conductive material, this end element can be used to generate an electrospray for coupling CE or CEC to mass spectrometry or light scattering or Chemiluminescent Nitrogen Detector (CLND). Compared to known assemblies, the end element according to the invention is very easy to handle. The end element holds very tightly to the capillary or chip channel, even when pressure is applied. No extra connected device is necessary.

Using the end element according to the invention instead of fused silica tips for electrospray devices has some major advantages. Since the end element can be made of plastic, the metal coating on plastic is more stable than on fused silica, so the average life time of a plastic tip is longer than of a fused silica tip. The tip shape is not limited to a few different geometries like with fused silica tips but almost every desired shape could be realized e.g. by fabricating them from plastic using a molding tool with the corresponding shape. Therefore it was very simple to design optimal tip-geometries for an optimal aerosol-formation. Furthermore the surface tension of the tip which is important for the stability of the spray could be controlled by using different materials for different separation conditions. The remaining open capillary part between tip and capillary is much smaller than in the commercial connector devices. It is possible to reduce it to a few hundred picoliters. Therefore an additional capillary zone electrophoresis (CZE) separation which could negatively influence the resolution of the system is negligible.

Another preferred embodiment of the end element comprises an attachment member to be connected to the capillary or chip channel and an outlet element of tapering cross section comprising an outlet orifice facing away from the capillary or the chip channel. This embodiment does not necessarily comprise a liquid-permeable membrane. The tapering cross section of the outlet element is retaining the carrier material up to a certain size. This embodiment has the same advantages as the embodiment described above.

Within both embodiments described above, the end element can be used as electrospray device by contacting the end element to a voltage source. Preferably, the outer surface and/or the inner surfaces of the end element are coated with metal or another electrically conductive material.

A method according to the invention for the packing of capillary columns or chip channels comprises the steps of filling the capillary column or the chip channel with a carrier material and connecting an end element as described above. Since the construction of the end element is adapted to the shape of the capillary or the chip channel, i.e. the attachment member of the end element is preferably cylindric, the end element can easily be plugged on the capillary column or be inserted in the chip channel. This can be done by hand or automatically without any special devices.

Preferably, the method comprises additionally the step of cutting the capillary to a length prior to connecting the end element. Since the end element can be connected, i.e. plugged on the capillary very easily, it is possible to use a long capillary having a length of e.g. 1 m, cutting this capillary into several capillaries of the desired length, e.g. 10 cm, and thereafter plugging the end elements on the capillaries. Thus, it is possible to produce a number of capillaries in only one short process by packing the long capillary with only one pressure cycle or one electrokinetic packing cycle or one cycle of another suitable packing method and cutting it into pieces before applying the end elements. This procedure is suitable for automated high throughput production.

Depending on the separation process the capillary or chip channel is used for, one or both ends of the capillary column or the chip channel are provided with an end element.

To produce such end elements, it is possible to form plastic cylinders by injection-molding with a centric hole of an inner diameter corresponding to the outer diameter of the column in such a way that the attachment member can be tightly pressed onto the capillary. The end element for a chip channel can also be produced by injection-molding whereby the cylindric attachment member has an outer diameter corresponding to the inner diameter of the chip channel. The choice of available polymers and porous membranes or microsieves is large, which means the material can be easily adapted to every special application or analyte. Alternatively the end elements could be made from glass e.g. with pores etched into the bottom, from ceramics or metal. By applying coatings to change the absorption behavior of the devices the range of applications can be even increased.

Hereinafter, preferred embodiments of the invention will be described in view of the attached drawings.

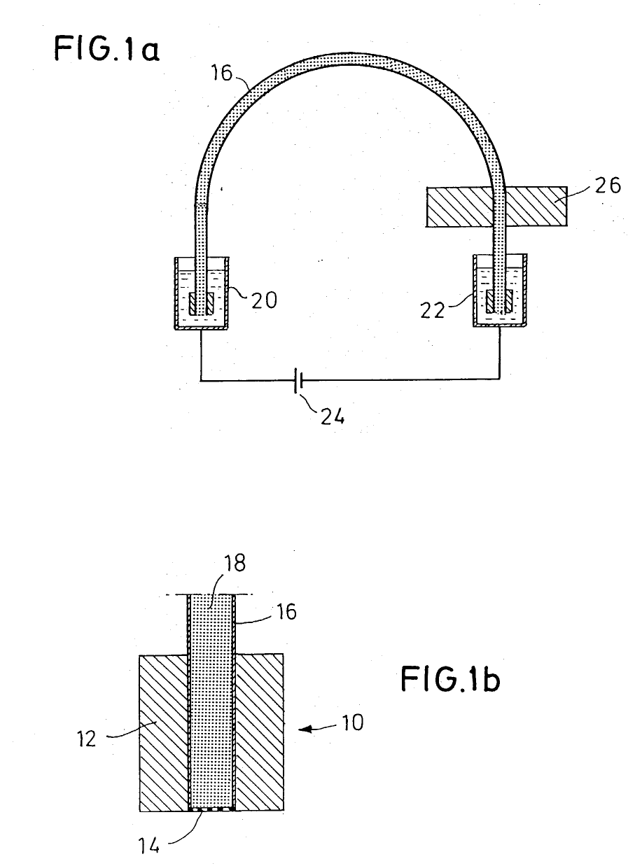

FIGS. 1a and 1b show a first embodiment of an end element used for the capillary electrochromatography (CEC).

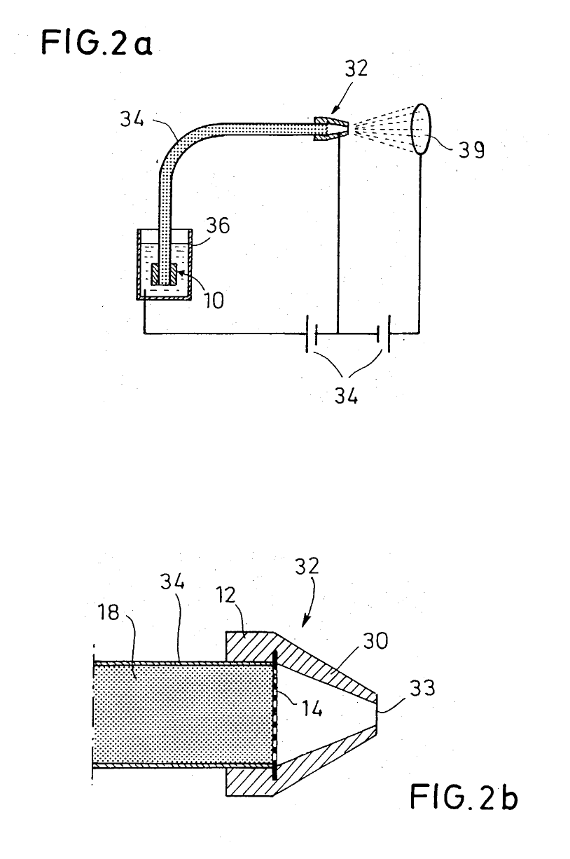

FIGS. 2a and 2b show an embodiment of the end element used as electrospraying device, whereby FIG. 2b is an enlarged view of the end element.

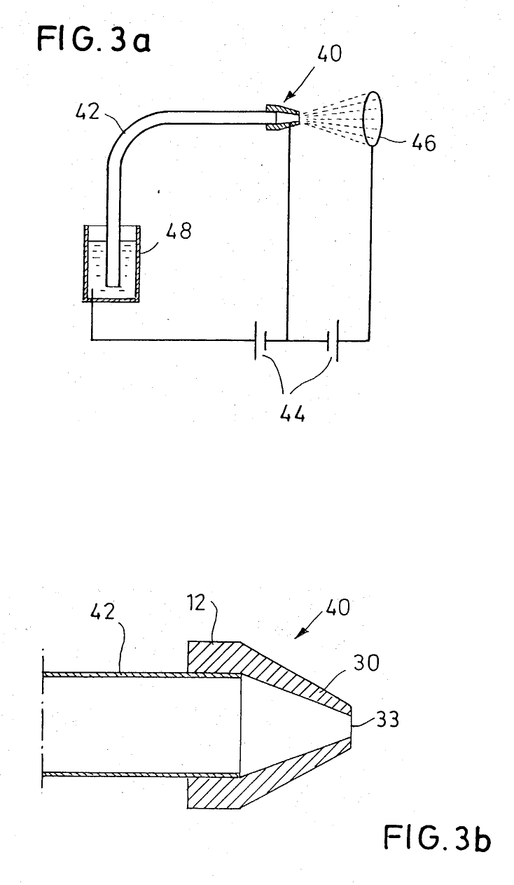

FIGS. 3a and 3b show another embodiment of the end element used as electrospraying device, whereby FIG. 3b is an enlarged view of the end element.

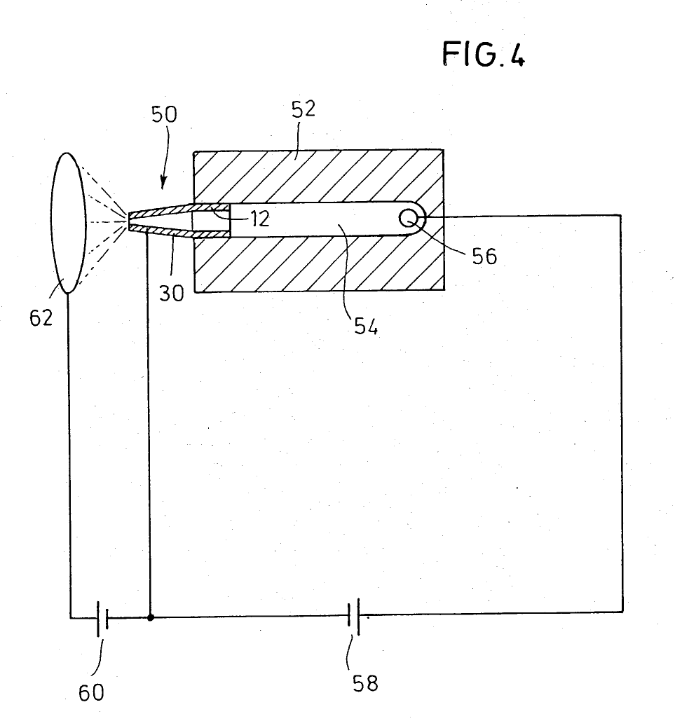

FIG. 4 shows another embodiment of the end element used in connection with a chip channel.

In the embodiment shown in FIGS. 1a and 1b, a cylindric end element 10 is used. The cylindric end element 10 comprises an attachment member 12 and a liquid-permeable membrane 14. The attachment member 12 is a hollow cylinder having an inner diameter that corresponds to the outer diameter of the capillary 16. The liquid-permeable membrane 14 is a porous film or a microsieve attached to one end surface of the attachment member 12 covering the cylindric hole of the attachment member 12. In other words, the membrane 14 is attached to the bottom of the attachment member 12 having a pore size corresponding to the particle size of the packing material packed into the column 16 to retain the packing material 18 within the column 16. By adapting the pore density to the density of the packing material, it is possible to obtain a constant EOF within the whole system. The membrane material is non-absorbant to the analyte.

A column as shown in FIG. 1a could for instance be prepared in the following way: The capillary, e.g. a fused silica capillary with an outer diameter of 360 μm, an inner diameter of 100 μm and a length of 50 cm is filled with a slurry consisting of 3 μm Hypersil C-18 beads suspended in a suitable solvent by applying a high pressure of 800 bar. To retain the beads in the capillary, its bottom is connected to an HPLC frit. With the pressure released therefrom, the column gets conditioned. After this process the column is cut into for instance 5 cm short pieces with a special capillary cutter to obtain very smooth cuts. Finally, the end elements 10 are tightly plugged onto the ends of the column 16 either by hand or with a special tool and the column is ready for use. Other packing methods like electrokinetic packing or centripetal packing can also be applied.

The inlet and outlet of the capillary 16 are inserted into inlet sample vessels 20 and outlet sample vessels 22, respectively. The vessels 20,22 are connected to a high-voltage source 24. The detection of the separated components can be performed via a UV absorber 26.

If the separated sample should be detected by mass spectrometry, light scattering techniques or any other method which requires an electrospray coupling, this can be done by a modification of the end element in which one end of the end element is formed like a tip (FIGS. 2a,2b). Therefore, the attachment member 12 is connected to an outlet element 30 to form another embodiment of an end element 32. The outlet element 30 is conical so that the inner diameter of the attachment member 12 is tapered to a smaller diameter serving as spray tip. Thus, the outlet element 30 comprises an outlet orifice 33 facing away from the capillary 34.

The end element 32 is plugged on one end of a capillary 34. At this end, the sample to be analyzed by mass spectrometry or the like. The end element 32 is connected to high-voltage sources 34. The conductivity of the end elements 32 can be obtained by coating with metal, e.g. gold with common coating procedures like spattering, evaporating techniques or the like. The conductivity can also be obtained by adding steel or carbon to the plastic granulate before the molding process.

The other end of the capillary 34 is terminated with an end element 10 as described in view of FIGS. 1a and 1b. This end of the capillary is dipped into a sample vessel 36 which is also connected to the high-voltage sources 34.

Another embodiment of an end element 40 used as electrospraying device is shown in FIGS. 3a and 3b. The end element 40 is similar to the end element 32 (FIG. 2b) whereby the end element 40 does not comprise a membrane. The end element 40 comprises an attachment member 12 and a conical outlet element 30. The end element 40 is plugged on the capillary 42 and is connected to high-voltage sources 44 to be used for a mass spectrometry, light scattering techniques or the like. Therefore, the sample to be analyzed is sprayed by the end element 40 in the direction of a counter electrode 46 that is also connected to the high-voltage sources 44.

The other end of capillary 42 is open and dipped into a sample vessel 48 that is also connected to the high-voltage sources 44. The system shown in FIGS. 3a and 3b is used for CE or when working with charged particles which are retained in the capillary 42 by electrical forces.

Another embodiment of an end element 50 used in connection with a chip element 52 is shown in FIG. 4. The end element 50 is used in microfabricated separation devices as chip CE, chip CEC or micro-HPLC. The chip element 52 comprises a chip channel 54. Using chip elements 52 as microfabricated separation devices, the separation channels are not single capillaries, as shown in FIGS. 1-3, but angular channels on a planar chip. A chip element 52 comprises a number of parallel orientated channels 54.

The end element 50 is not plugged onto a capillary, as shown in FIGS. 1-3, but inserted into the channel 54. Therefore, the outer diameter of an attachment member 12 corresponds to the inner diameter of the channel 54. The attachment member 12 is connected to an outlet element 30 corresponding to the one described in view of FIGS. 2 and 3. The outlet element 30 is conical.

To use the chip element 52 as electrospraying device, an electrode 56 is located within the channel 54. The electrode 56 is connected to a high voltage source 58. The end element 50 is connected to the high voltage source 58 and to a second high voltage source 60. The high voltage source 60 is furthermore connected to a counter electrode 62.

1. An end element for capillaries (16, 34) or chip channels for use in capillary electrophoresis or in capillary electrochromatography, liquid chromatography and micro-liquid chromatography or in high performance liquid chromatography, comprising
an attachment member (12) to be connected to the capillary (16, 34) by plugging on or to the chip channel by insertion and
a liquid permeable membrane (14) terminating the capillary (16, 34) and the chip channel, respectively, and provided for retaining carrier material (18) contained in the capillary (16, 34) and the chip channel, respectively.

2. The end element according to claim 1, characterized in that the liquid-permeable membrane (14) comprises a microsieve or a porous film.

3. The end element according to claim 2, characterized in that the membrane (14) has a pore size of less than 50 μm.

4. The end element according to claim 2 or 3, characterized in that the pore density is at least 4%, preferably at least 10%, and most preferably at least 25%.

5. The end element according to any one of claims 2 to 4, characterized in that the pores are distributed substantially homogeneously across the surface of the membrane.

6. The end element according to any one of claims 1 to 5, characterized in that an outlet element (30) of tapering cross section is provided, comprising an outlet orifice (33) facing away from the capillary (34) and the chip channel, respectively.

7. An end element for capillaries (34, 42) or chip channels for use in capillary electrophoresis or in capillary electrochromatography, liquid chromatography and micro-liquid chromatography or in high performance liquid chromatography, comprising
an attachment member (12) to be connected to the capillary (34, 42) by plugging on or to the chip channel by insertion and
an outlet element (30) of tapering cross section comprising an outlet orifice (33) facing away from the capillary (34, 42) and the chip channel, respectively.

8. The end element according to claim 6 or 7, characterized, in that the outlet element (30) is conical.

9. The end element according to any one of claims 1 to 8, characterized in that the attachment member (12) comprises a hollow cylinder with its inner diameter corresponding to the outer diameter of the capillary (16,34,42).

10. The end element according to any one of claims 1 to 9, characterized by the outer diameter corresponding to the inner diameter of the chip channel.

11. The end element according to any one of claims 1 to 10, characterized in that the end element (32,40) is connected to a voltage source to be used as electro spraying device.

12. A method for the packing of capillary columns or chip channels for use in capillary electrochromatograhy, liquid chromatography and micro-liquid chromatography or in high performance liquid chromatography, comprising the following steps:
filling the capillary column or the chip channel with carrier material, and
connecting an end element according to any one of claims 1-10 to the capillary or the chip channel.

13. The method according to claim 12, characterized by cutting the capillary to length prior to connecting the end element.

14. The method according to claim 12, characterized by cutting a long capillary filled with carrier material into a plurality of capillaries of the desired length prior to connecting the end element.

15. The method according to any one of claims 12 to 14, characterized by connecting a respective end element to both ends of the capillary column or chip channel.

16. A capillary comprising at least one connected end element according to any one of claims 1 to 11.

17. A capillary comprising at least one connected end element according to any one of claims 1 to 11 used for preconcentration.
